(19) United States
(12) Patent Application Publication
(10) Pub. No.: US 2008/0201327 A1
(43) Pub. Date: Aug. 21, 2008

(54) Identity match process

(76) Inventor: Ashoke Seth, Phoenix, AZ (US)

Correspondence Address: ETHERTON LAW GROUP, LLC, 5555 E. VAN BUREN STREET, SUITE 100, PHOENIX, AZ, 85008, US

(21) Appl. No.: 12/070,455

(22) Filed: Feb. 19, 2008

Related U.S. Application Data
(60) Provisional application No. 60/902,191, filed on Feb. 20, 2007.

(51) Int. Cl. G06F 7/10; G06F 17/30

(52) U.S. Cl. 707/5; 707/E17.023

(57) ABSTRACT

An online computer system enables users to identify and contact, if they so desire, users with similar attributes. The primary method of matching identity matches facial and at least one other physical, astrological, or other defined attribute. This matching is done by computer comparison of the photographs and other data provided by the users. The users may be provided with information to contact any matches.

### CROSS-REFERENCE TO RELATED APPLICATIONS

This application claims the benefit of co-pending provisional application No. 60/902,191, filed Feb. 20, 2007.

### FIELD OF INVENTION

The present invention relates to computer-based social networking services.

The present invention relates specifically to the use of the Internet to connect users of a service to each other based on certain defined attributes.

### BACKGROUND

Social networking services are known in the art and have existed for a number of years. Such services typically maintain a database of people who have expressed an interest in meeting other people with whom they share an association or common interest. Some services allow users to access the database via computer networks such as the Internet, which provides users with a way to locate people across a broader pool than may be compatible with the user's interests and preferences. These services have rapidly gained popularity with well-known services such as MySpace® and FaceBook®.

In a typical on-line service, a user registers with the service and provides extensive background information. The information typically includes contact information and personal information such as the user's occupation, income, educational level, hobbies, interests, religion, children, smoking habits, drinking habits and appearance, including height, weight and race.

The present social networks enable a user to seek others based on characteristics desired by the user, but unless the user specifies that his desires are identical to himself, the social network does not seek others identical to the user. It would be interesting to find others that are identical to one's self. In addition, current social networks do not enable users to search based on facial appearance, which is difficult to define in words or a discrete set of objective factors. With the emergence of facial recognition software, it is possible to search for faces that look like each other, the extreme example being identical twins. It would be desirable to enable a user to search for others who actually look like him. More generally, it would be desirable to enable a user to search for those who match any given face.

Therefore, it is an object of this invention to enable users of a social networking service to identify and meet other users who have a strong physical resemblance to a given face, particularly the user's. It is another object of this invention to augment facial similarity with astrological, geographical, and personality data to allow users to find others who are similar to them. It is a further object of this invention to facilitate communication between users who desire to contact their matches.

### SUMMARY OF THE INVENTION

The invention is an online computer system that enables users to identify and contact, if they so desire, users with similar attributes. The primary method of matching identity matches facial and at least one other physical, astrological, or other defined attribute. This matching is done by computer comparison of the photographs and other data provided by the users. The users will also have the option of sharing contact information with each other confidentially, without compromising their privacy and security.

### BRIEF DESCRIPTION OF THE DRAWINGS

FIG. 1 is a schematic illustration of a communication system between an identity matching service and its users.

FIG. 2 is a flow chart illustrating the overall process.

FIG. 3 is a flow chart illustrating in general the three stages of the identity matching system.

FIG. 4 is a flow chart illustrating in more detail the process of the data gathering stage.

FIG. 5 is a flow chart illustrating the process of the identity matching stage.

FIG. 6 is a flow chart illustrating the process of the communication stage between a registered user and a matched user.

### DETAILED DESCRIPTION OF THE INVENTION

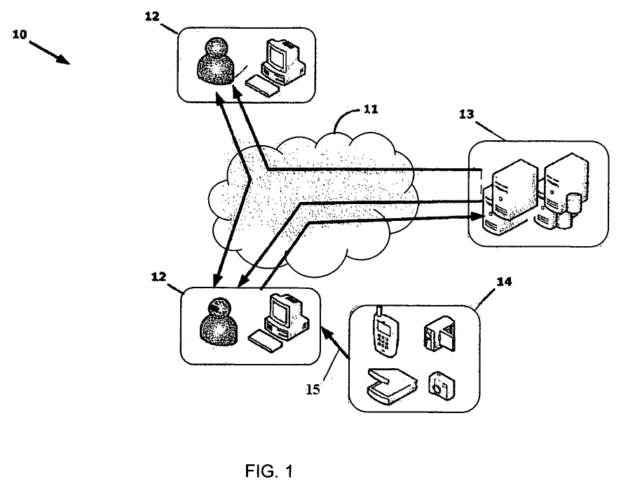

Referring to FIG. 1, a profile-matching system 10 includes one or more computer networks 11 that facilitate communication between an identity service 13 and one or more remote units 12. Networks 11 are communication networks such as internet, intranet, extranet, virtual private networks, wireless networks, TCP/IP and non TCP/IP based networks. In the preferred embodiment, networks 11 are internet-based networks. The identity service 13 comprises one or more processing units, which host and manage facial recognition software, search engine software, and other software components for performing methods and functions described in this application. In the preferred embodiment, a processing unit of identity service 13 also includes an expert system to learn and take advantage of individual identity match preferences. This increases the efficiency of the profile-matching system 10 by eliminating redundant and extraneous data. A remote unit 12 can be any device capable of interacting with a communication network 11, such as a desktop computer, laptop computer, workstation, server, ultra mobile internet communication devices, cell phone or other mobile phone, or personal digital assistant (PDA). In the preferred embodiment, the remote unit 12 is a desktop computer.

A user of the remote unit 12 accesses the identity service 13 using web pages for entering user profile information and answers to identity matching inquiries, email and instant messaging for establishing communication. A user of the remote unit 12 transfers images from an image source 14, which can be any device capable of capturing or storing an image, or both, electronically, such as a digital camera, scanner, video, or cell phone or other mobile camera, to the remote unit 12 using a communication method 15. The communication method 15 can be any hard-wired or wireless method for transferring electronic data, such as an ethernet or USB cable or a wireless network connection. The user of the remote unit 12 then transmits the images to the identity service 13. The user of the remote unit 12 can communicate with another user of a remote unit 12. The identity service 13 provides the communication by receiving a request from the first user and establishing communication to the other user. The identity service can mask real identity information including name, email, and other contact information, to facilitate identity protection based on each user's preferences. Users can establish direct communication by sending an acceptance signal to the identity service 13, authorizing the identity service 13 to reveal the users' real identity or to initiate direct contact between the users. In this way, have the option of sharing contact information with each other confidentially, without compromising their privacy and security.

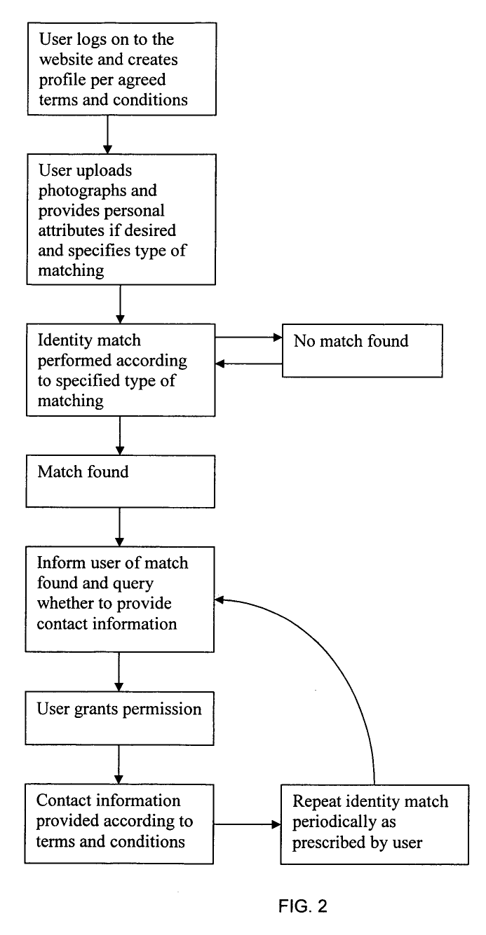

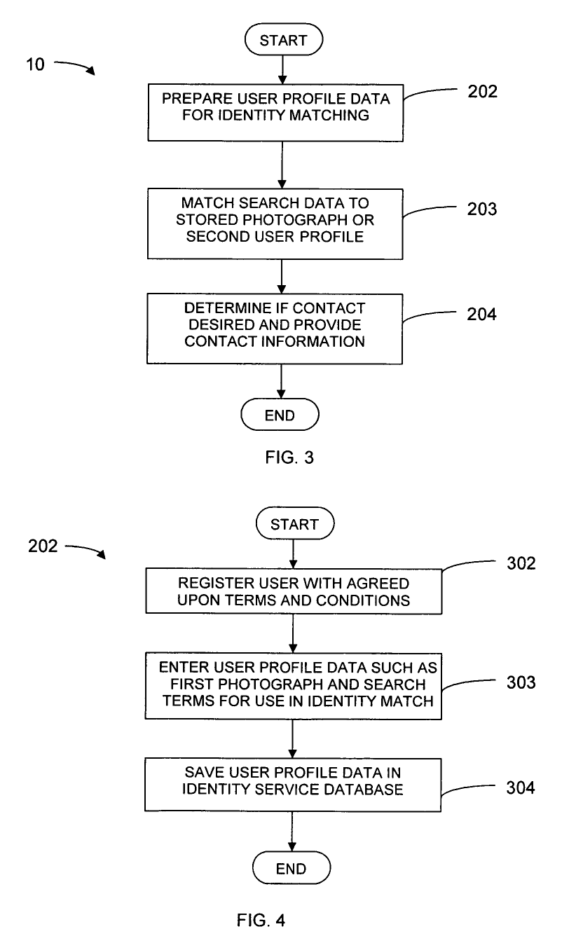

FIG. 2 shows the overall process of the profile-matching system 10. The overall process can be divided into three stages as shown in the process flow diagram of FIG. 3: a data gathering stage 202, an identity matching stage 203, and a communication facilitation stage 204. Referring to FIG. 4, the data gathering stage 202 starts with user registration 302. The user accesses the identity service 13 and creates an account using a username and password of his or her choice (both genders referred to in the masculine herein). The user digitally signs an acceptance of the policies and procedures and chooses whether to give his permission under prescribed conditions to search for his match. The user thereby becomes registered with the identity service 13 and gains access to search functionality. The user enters 303 his user profile by providing his contact information, which is required, and at least one search term he would like to be used for identifying his match. Search terms in the user profile may be personal attributes such as, but not limited to, physical, mental, psychological, medical, philosophical, political, geographical, professional, religious, astrological, athletic, and recreational traits, as well as social, behavioral, and miscellaneous personal traits. Examples of these attributes are listed in Appendix A. The user profile is stored 304 in an identity service database in a secure fashion, along with an identifier which associates the user profile with the user. The identity service database 305 contains user profile information for all registered users of the identity service 13. The user may choose to upload photographs into the identity service database 305 that will be used to compare against other photos in the identity matching stage 203. The submitted photographs can be of the user, other people, animals, or inanimate articles such as antiques, paintings, fine art, or jewelry. When a user submits a photograph into the identity service database 205, that photograph is identified as being related to the user that submitted it. Thus, a photograph does not have to portray the user to be related to the user.

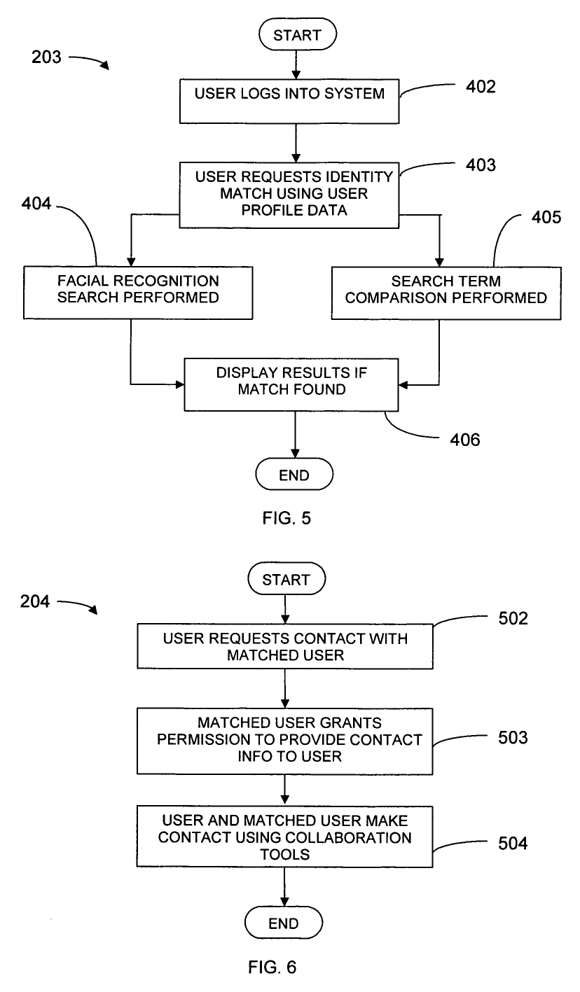

Referring to FIG. 5, the identity matching stage 203 starts with the user logging on 402 and requesting an identity match based on a submitted photograph, a set of search terms relating to specified personal attributes 403, or a combination of both. The submitted photograph used in the search is referred to herein as the first photograph. Identity matches can be requested in batch mode or real time. Depending on the requested parameters of the identity match, the identity service 13 performs a facial recognition search 404, a comparison 405 of the search terms to personal attributes of other users, or both. For the facial recognition search 404, the identity service 13 may employ facial recognition software, such as that available commercially from Cognitec Systems, L-1 Identity Solutions, or Geometrix, or proprietary facial matching software. Both color and black-and-white photographs and video can be matched. The facial matching software compares a face in the first photograph to faces in stored photographs contained in the database 305. In the preferred embodiment, the database 305 contains stored photographs relating to other users, referred to herein as second users, and the facial recognition search attempts to find second users that have a similar facial appearance to the requesting user. Stored photographs that minimally match the first photograph are marked for inclusion the search results. If a minimally-matching stored photograph is contained in a user profile, the second user related to that user profile is marked as a matched user and will also be included in the search results. If there are matched users or minimally matching stored photographs, the search results are displayed 406 to the user once the search is complete.

A baseline is determined for “minimally matching” photographs. For example, a stored photograph may minimally match the first photograph if the facial recognition software detects at least a 50% similarity between the facial features of the faces in the two photographs. The baseline may compare facial features such as degree of facial roundness; eye color, size, and placement relative to the other eye or other facial features; size, shape, and position of nose; cheekbone structure; distance between browline and hairline or mouth to chin. The percentage of similarity is determined by algorithms in the facial recognition software. For example, if the first photograph features a distance between the eyes of 35 mm and the stored photograph features a distance between the eyes of 36 mm, the facial recognition software may calculate a percentage of similarity based on the initial distance of 35 mm and the 1 mm difference between the photographs. The facial recognition software may also refer to a lookup table which includes preset similarity percentages. The baseline may be a predetermined baseline set by the identity service 13, or the baseline may be defined by the user. The user definition of minimally matching may emphasize certain facial features over others. For example, the user may demand a high degree of similarity in the cheekbone structure of the faces while de-emphasizing the shape and color of the eyes. The user definition of minimally matching may be more or less restrictive than the default definition.

Photographs may be matched by non-facial features as well, such as body shape, body proportion, hair color, hair length and style, etc. For minimally matching photographs of features of inanimate articles, the system may compare features such as shape of the object's periphery, color, or surface detail.

In an alternate embodiment, the database 305 contains stored photographs of celebrities. A celebrity is defined herein as a famous or well-known person or public figure, including a person who has appeared on television, in a film, or whose face is recognizable due to that person's contributions to or effect on society. In this embodiment, the facial recognition search 404 compares the first photograph to the stored photographs of celebrities and search results listing the user's celebrity look-alikes are displayed 406. Alternatively, the database 305 also contains stored photographs of second users and the user may ask the identity matching system to search for a second user who looks like a specified celebrity. In another embodiment, the user submits a photo of his pet, and searches for second users who have pets that look like his. In yet another embodiment, the user can search for ancestors or estranged family members by submitting a photo of himself or other family member and asking the identity matching system to search for a second user who looks like the submitted photo.

In conjunction with the identity service 13, the personal attribute search 405 attempts to find second users that have one or more personal attributes similar to the requesting user's search terms. For example, if the user was born on November 17, the user may ask the system to search for second users who looks like the user and have the astrological sign of someone born on November 17, namely a Scorpio. The identity match service may employ certain personal attribute search capability including, but not limited to, leading search engines like Yahoo!®, Google®, Microsoft®, or a proprietary custom attribute search engine.

The facial recognition 404 and personal attribute 405 searches may be performed serially or in parallel. The facial recognition 404 and personal attribute 405 searches may be conducted on the entire database 305 of user profiles. Because the database 305 may contain a large number of user profiles, the user may increase the efficiency of the searches by specifying required attributes that generate a discrete subset of user profiles from the database 305. For example, the user may choose to search for matching profiles of second users within a certain geographic region or age range. When a match is found, the facial recognition search 404 may calculate a numerical representation of the degree of similarity between the first photograph and the stored photograph. The personal attribute search 405 may determine a numerical degree of similarity between the search attributes and the relevant stored personal attributes. Search results are ranked and displayed 406 in order from the highest to lowest degree of similarity. If no match is found, the user will be informed so and a search will be repeated periodically to determine if a match is found at a later date. The user may identify how often he would like this search to be conducted.

Referring to FIG. 6, the user can initiate contact with matched users by requesting 502 communication with them in the communication facilitation stage 204. Once the user requests 502 communication with matched users, the identity service 13 sends notification to matched users and requests permission to share their real identity and contact information with the requesting user. Once a matched user grants 503 permission to share his real identity and contact information, the users are notified about the permission status and provided contact information, and can use any communication method suitable to contact 504 each other, such as by cell phone or online collaboration tools such as instant messaging, email, or status messages during login. In the preferred embodiment, the requesting user selects one or more communication method on which to contact and be contacted by matched users. If the matched user agrees to share the information, the identity match service reveals the matched user's identity to the requesting user to allow the users to establish communication directly between themselves.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

### APPENDIX A

Physical—facial, age, race, gender, income group, skin color, eye color, hair color, height, weight, and the presence or absence of any physical disabilities
Mental—being or not being mentally normal, having or not having a condition related to ADD (Attention Deficit Disorder), ADHD (Attention Deficit Hyperactivity Disorder), autism, borderline personality disorder, fragile X-syndrome, rett syndrome, social phobia
Psychological—being or not being psychologically normal, having or not having a condition related to anxiety disorder (panic, obsessive compulsive, post traumatic stress, social phobia, separation anxiety, substance-induced anxiety), depressive disorder (chronic depression, mild depression, bipolar disorder, seasonal disorder, postpartum, postnatal depression disorder) personality disorder (antisocial, conduct, defiant, multiple personality, paranoid, schizophrenic, narcissistic, dependent, avoidant disorder), eating disorder (anorexia, bulimia, binge eating disorder) or psychotic disorder (delusional, shared psychotic, or substance-induced psychotic disorder)
Medical—healthy, having a specified disease or disability, blood type, bone marrow type
Philosophical—pro or anti abortion, pro or anti gay marriage, pro or anti gun control, pro or anti pre-marital sex, pro or anti divorce, pro or anti polygamy, pro or anti war, agreeing or not with organ transplant, agreeing or not with stem cell research, and whether or not they believe that global warming is a real threat.
Political—left, right, middle, situational, undeclared, green, liberal, conservative, libertarian, anarchist
Geographical—being or not being originally from any particular continent, country, and state or city as well as currently living or not living in any particular continent, country, and state or city
Occupation or Profession—being or not being a blue collar or white collar worker, being or not being an individual contributor, being or not being a manager, being or not being an hourly worker, being or not being in medical profession, being or not being in legal profession, being or not being a business owner, being or not being a politician, being or not being in any of the armed services, being or not being in an academic profession, being or not being a student
Religious—being or not being a part of any particular religion, believing or not believing in God, believing or not believing in destiny
Astrological—believing or not believing in astrology, believing or not believing in Vastu Shastra, believing or not believing in Feng Shui, being or not being of a particular zodiac sign, having been or not having been born in any particular continent, country, state or city, any particular date, and any particular time.
Athletic—being or not being athletically oriented, liking or not liking physical fitness activities (exercise, hiking, biking, running, swimming), playing or not playing any of the sports (football, soccer, baseball, basketball, softball, tennis, golf, badminton, table tennis, ice hockey, field hockey, cricket, crocket, wrestling, boxing, shooting), watching or not watching any of the sports (football, soccer, baseball, basketball, softball, tennis, golf, badminton, table tennis, ice hockey, field hockey, cricket, crocket, wrestling, boxing, shooting)
Recreational Traits—liking or not liking water sports (water polo, jet skiing, water skiing, scuba diving, snorkeling, kayaking, whitewater rafting, deep see fishing, fishing), liking or not liking air sports (parasailing, gliding, sky diving, cliff diving, bungy jumping,), liking or not liking any snow sports (cross country skiing, downhill skiing, snow mobiling, liking or not liking any particular type of music (jazz, classical, pop, rock-n-roll, techno, disco, metal, hard rock), liking or not liking any particular type of movies (action, drama, western, comedy, thriller, suspense, horror, cartoons, animation), liking or not liking travel, liking or not liking reading any particular type of books (fiction, scientific, novels, magazines, newspapers, comics), liking or not liking any particular type of video games (X-box, Nintendo, PS1/2/3), liking or not liking to watch television, liking or not liking Martial Arts (Taichi, Karate, Judo, Kung Fu), liking or not liking travel, liking or not liking gambling, liking or not liking internet surfing
Social—being or not being a member of a social club, being or not being a member of a fraternity, being or not being a member of a sorority, being or not being a morning person, being or not being a people person, smoking or not smoking, drinking or not drinking (mixed drinks, wine, liquor, beer)
Behavioral—being or not being behaviorally normal, having or not having a condition related to alcohol abuse, drug abuse, substance abuse, gambling, eating, or sexually abusive behavior.
Personal—driving or not driving any particular type of vehicle, having or not having organizational skills, liking or not liking household chores, liking or not liking people with any particular type of personalities (dominating, submissive, neutral), liking or not liking conflicts, liking or not liking any particular celebrities (politicians, film stars, athletes), liking or not liking any particular type of pets (dogs, cats, horses, reptiles, snakes . . . ).

I claim:

1. A method for facilitating communication between users comprising:
a) providing a first photograph related to a first user;
b) comparing the first photograph to a stored photograph related to a second user;
c) if the first photograph minimally matches the stored photograph related to the second user, querying the first user to determine whether the first user wants to communicate with the second user and querying the second user to determine whether the second user wants to communicate with the first user; and
d) if the first user and second user want to communicate with each other, providing information to the first user and second user for them to contact each other.

2. The method of claim 1 further comprising:
a) displaying the stored photograph to the first user; and
b) displaying the first photograph to the second user.

3. The method of claim 1 further comprising:
a) if the first photograph minimally matches the stored photograph related to the second user, adding an identifier related to the second user to a list of matching users; and
b) displaying the list of matching users to the first user.

4. The method of claim 3 further comprising:
a) if the first photograph minimally matches the stored photograph related to the second user, calculating a degree of similarity between the first photograph and the stored photograph; and
b) adding the degree of similarity along with the identifier related to the second user to the list of matching users.

5. The method of claim 1 further comprising repeating the steps b-d after a predetermined interval has elapsed.

6. The method of claim 1 in which providing the first photograph is accomplished by uploading the first photograph to a database via a computer network.

7. The method of claim 1 in which the stored photograph related to the second user is stored in a database with a plurality of other stored photographs related to a plurality of other users.

8. The method of claim 1 in which providing the information to the first user and second user for them to contact each other is accomplished via a computer network.

9. A method for facilitating communication between users comprising:
a) providing a first photograph related to a first user and at least one search term;
b) comparing the first photograph to a second photograph related to a second user;
c) comparing the search term to at least one personal attribute related to the second user;
d) if the first photograph minimally matches the stored photograph and at least one search term matches at least one personal attribute, querying the first user to determine whether the first user wants to communicate with the second user and querying the second user to determine whether the second user wants to communicate with the first user; and
e) if the first user and second user want to communicate with each other, providing information to the first user and second user for them to contact each other.

10. The method of claim 9 further comprising:
a) displaying the stored photograph to the first user; and
b) displaying the first photograph to the second user.

11. The method of claim 9 further comprising:
a) if the first photograph minimally matches the stored photograph and at least one search term matches at least one personal attribute, adding a user profile related to the second user to a list of matching user profiles; and
b) displaying the list of matching user profiles to the first use r.

12. The method of claim 11 in which the user profile related to the second user is stored in a database with a plurality of other user profiles related to a plurality of other users.

13. The method of claim 9 further comprising:
a) if the first photograph minimally matches the stored photograph and at least one search term matches at least one personal attribute, calculating a degree of similarity between the first photograph and the stored photograph; and
b) adding the degree of similarity along with the identifier related to the second user to the list of matching users.

14. The method of claim 9 further comprising repeating steps b-e after a predetermined interval has elapsed.

15. The method of claim 9 in which providing the first photograph comprises uploading the first photograph to a database via a computer network.

16. The method of claim 9 in which providing the information to the first user and second user for them to contact each other is accomplished via a computer network.

17. A method for facilitating communication between users comprising:
a) uploading a first photograph related to a first user to a database via a computer network;
b) comparing the first photograph to a stored photograph of a celebrity;
c) if the first photograph minimally matches the stored photograph of a celebrity, displaying the stored photograph of a celebrity to the first user; and
d) notifying a second user that the first photograph related to the first user minimally matches the stored photograph of a celebrity via a computer network.

18. The method of claim 7 further comprising:
displaying the first photograph related to the first user and the stored photograph of a celebrity to the second user.

19. The method of claim 7 in which the photograph of a celebrity is stored in a database with a plurality of other photographs of celebrities.

20. A method for facilitating communication between users of a computer-based identity matching system, the method comprising:
a) collecting first user profile data relating to a first user, the first user profile data comprising:
i. first user contact information;
ii. a first photograph; and
iii. at least one first user personal attribute;
b) providing a user profile database having at least one record comprising:
i. an identifier relating to a second user;
ii. stored user contact information;
iii. a stored photograph; and
iv. at least one stored personal attribute;
c) at the request of the first user, comparing the first user profile data to at least one record in the user profile database; and
d) for each record to which the first user profile data is compared, if the first photograph minimally matches the stored photograph and at least one search attribute matches at least one stored personal attribute:
i. displaying the stored photograph and at least one stored personal attribute contained in the record to the first user;
ii. querying the first user to determine whether the first user wants to communicate with the second user;
iii. if the first user wants to communicate with the second user, querying the second user to determine whether the second user wants to communicate with the first user; and
iv. if the second user wants to communicate with the first user, providing the first user contact information to the second user and providing the stored user contact information to the first user.
